(19) United States
(12) Patent Application Publication
(10) Pub. No.: US 2024/0251828 A1
(43) Pub. Date: Aug. 1, 2024

(54) APPARATUS AND PROCESS FOR DEBITTERING OLIVES AND OLIVES OBTAINED THEREBY

(71) Applicant: UNIVERSITY OF SOUTH AUSTRALIA, ADELAIDE (AU)

(72) Inventor: John FIELKE, Mawson Lakes (AU)

(73) Assignee: UNIVERSITY OF SOUTH AUSTRALIA, ADELAIDE, SA (AU)

(21) Appl. No.: 18/578,866

(22) PCT Filed: Jul. 14, 2022
(86) PCT No.: PCT/AU2022/050738

§ 371 Date: Jan. 12, 2024

(30) Foreign Application Priority Data
Jul. 14, 2021 (AU) 2021902147

(51) Int. Cl. A23L 5/20; C02F 1/42; C02F 103/32

(52) U.S. Cl. CPC A23L 5/27; C02F 1/42; C02F 2103/32; C02F 2209/05; C02F 2209/06; C02F 2209/42; C02F 2303/16

(57) ABSTRACT

The present disclosure relates to a process for debittering olives without intentional fermentation or lye treatment, the process comprising: providing at least one container loaded with olives; contacting an aqueous acidic brine with the olives under conditions sufficient to release at least some of any bitter compounds therefrom; and contacting the aqueous acidic brine with an adsorbent resin so as to remove one or more of any bitter compounds or colouring compounds from the aqueous acidic brine that has been in contact with the olives.

### PRIORITY DOCUMENT

The present application claims priority from Australian Provisional Patent Application No. 2021902147 titled “APPARATUS AND PROCESS FOR DEBITTERING OLIVES AND OLIVES OBTAINED THEREBY” and filed on 14 Jul. 2021, the content of which is hereby incorporated by reference in its entirety.

### TECHNICAL FIELD

The present disclosure relates generally to the processing of olives for consumption. Specifically, the present disclosure relates to apparatus and process for debittering olives and olives obtained thereby.

### BACKGROUND

Raw olives are far too bitter to eat. The bitterness arises from high levels of bitter phenolic compounds, including oleuropein and ligstroside, present in raw olives. Therefore, harvested olives must undergo some form of processing, fermentation or curing to remove or reduce the bitterness in order to make them edible. Saltiness and bitterness of olives are key properties that affect the palatability of table olives.

Numerous methods have been developed to transform olives from a bitter drupe into an edible fruit, and these methods may involve acid, base, and/or enzymatic hydrolysis of the bitter phenolic compounds naturally present.

The traditional method for debittering olives is fermentation in a brine solution. The process can start with daily brine changes for a week after which fermentation is allowed to occur. Fermentation makes the brine acidic and the acid helps release the oleuropein from the olives. For this process there are several key factors that must be controlled to create a quality table olive. Firstly, the salt concentration of the brine must start at around 10% and be maintained at above 5%. The salt is absorbed by the olives from the brine. Secondly, as the fermentation progresses, the pH of the brine will reduce to around 4. Using fermentation is not particularly suitable for table olive production on a large commercial scale as it needs intensive monitoring and adjustments to and cleaning of the brine so as to ensure that fermentation is occurring over a 2 to 12 month period without unwanted moulds being formed. These moulds, if left unchecked, will result in the whole container of olives being unsaleable. Thirdly, the inter-cellular air in the olives slowly moves from the olives and the olives shrink in volume, resulting in the level of brine in a barrel dropping by around 5 to 10%. This loss of brine may leave some olives exposed to air and moulds may form on them. Thus, the brine needs to be replenished on a regular basis. Regular inspections and adjustments with respect to the brine level, salinity and removal of moulds as well as confirmation of fermentation using pH measurements for each individual container must be undertaken ideally on a weekly basis to confirm all is okay or for an intervention to take place. One such intervention is the changeover of the brine or the addition of a yeast culture to promote fermentation. This means that if a large number of containers of olives are used many checks and adjustments must be undertaken. Moreover, multiple changes of brine would use large quantities of water and result in large volumes of saline/acidic wastewater.

A common commercial process for creating mass produced table olives uses a lye based process. The lye takes around 24 hours to permeate into the olive and release the bitter compounds from the olives and then about two weeks of daily water changes to remove the toxic lye flavour from the olives. This process produces an even larger quantity of wastewater because of multiple rinses. For example, olives that are prepared using lye can use over five times the amount of potable water compared with natural fermentation methods. The resulting wastewaters are problematic because they contain high organic matter, high phenolic content and high salinity. The volume and the chemical characteristics of the wastewaters pose a significant environmental problem. Currently, the most common wastewater treatment is storage of the wastewaters in large evaporation ponds where, during the dry season, the wastewater disappears due to evaporation. This is not always an effective solution as the evaporation depends on the climate and has a number of associated problems, such as bad odours and insect proliferation.

Olive processing methods that do not use as much water have also been trialled so as to reduce production of wastewater. For example, ozone treatment has been proposed to break down the characteristic polyphenols present in the fermentation brines of olives (see K. A. Segovia-Bravo, P. Garcia-Garcia, et al., Ozonation process for the regeneration and recycling of Spanish green table olive fermentation brines, European Food Research and Technology 227(2):463-472). However, this method is of high cost and involves relatively specialised equipment and complex operations. WO2014193567A1 discloses a method for debittering olives, which includes contacting olive flesh with a granular polymeric resin to remove one or more bitter compounds therefrom. The resin may be selected from polystyrene/poly(divinylbenzene) resin, an acrylic ester resin and/or a polyvinylpolypyrrolidone resin. However, this method has several practical difficulties to implement on a large scale. Firstly, a large volume of resin is required so that it can be in contact with each olive. Their testing used a ratio of 1:1 of olives to resin. That means equal volumes of olives and resin. The high volume of resin required will make the process quite difficult to be financially viable due to the requirements for initial purchase, materials handling, storage and replenishment. Secondly, the method will work best with very small diameter size resin particles which give a larger surface area, but these resins are very difficult to separate from the olives and brine as they easily get caught in notches and defects in the olives and may become an unwanted contaminant in a final product. Thirdly, due to the large size difference between the olives and the resin, the resin easily sinks to the bottom of the container and the olives work their way up to the top of the resin, a process called consolidated trickling. Hence, it is difficult to maintain a large volume of olives in direct contact with the resin.

Attempts have also been made to regenerate spent brine used to treat olives in order to improve the processing of table olives. For example, NL1005938 (C2) discloses a method of treating organic products (e.g. olives) in salt solution which is characterised in that the undissolved organic constituents or the inorganic contaminants are subsequently removed from the spent salt solution by means of a filter such as ceramic and/or organic micro-filter, ultra-filter, nano-filter or hyper-filter, after which at least part of the salt solution is regenerated for reuse.

Olives like other fruit have a percentage of intercellular air. When they are placed in a brine, the air is expelled and the olives shrink, resulting an about 5-10% reduction in the volume of contents. Thus, if a container storing fresh olives is to remain filled, it must be topped up over time.

The saltiness and bitterness of table olives that are produced using known olive processing methods are, by and large, a result of the processing methods used rather than a desire to tailor the olives to have specific or desired levels of saltiness or bitterness.

There remains a demand for processes and apparatus for debittering olives that can alleviate or solve one or more of the above problems while maintaining the quality of table olives. Alternatively, or in addition, there is a demand for processes and apparatus that can be used to tailor the properties of olives that give rise to palatability.

### SUMMARY

In a first aspect, the present disclosure provides a process for debittering olives without intentional fermentation or lye treatment, the process comprising:
providing at least one container loaded with olives;
contacting an aqueous acidic brine with the olives under conditions sufficient to release at least some of any bitter compounds therefrom; and
contacting the aqueous acidic brine with an adsorbent resin so as to remove one or more of any bitter compounds or colouring compounds from the aqueous acidic brine that has been in contact with the olives.

In some embodiments of the first aspect, the at least one container is composed of a plurality of containers that are connected in fluid communication with one another.

In some embodiments, the aqueous acidic brine within the at least one container is maintained at a desired value of pH that is no higher than about 4.3 and at a desired value of salinity that is at least about 5% w/v of the aqueous acidic brine.

In some embodiments, the adsorbent resin is an ion exchange resin. In some other embodiments, the adsorbent resin is a non-ionic adsorbent resin. In some other embodiments, the adsorbent resin is a chelating adsorbent resin.

In some embodiments, the adsorbent resin is disposed within one or more of the containers. In some other embodiments, the adsorbent resin is disposed external to the at least one container.

In some embodiments, a sensor for measuring pH of the aqueous acidic brine is used to monitor the pH of the brine. In certain of these embodiments, the pH of the aqueous acidic brine is monitored and adjusted on a regular basis.

In some embodiments, a sensor for measuring salinity of the aqueous acidic brine is used to monitor the salinity of the brine. In certain of these embodiments, the salinity of the aqueous acidic brine is monitored and adjusted on a regular basis.

In some embodiments, a sensor for measuring brine level of the aqueous acidic brine is used to monitor the reduction in the brine level. In certain of these embodiments, the brine level of the circulating aqueous acidic brine is monitored and adjusted on a regular basis.

The measured brine level or volume, pH and salinity values can be used to keep the aqueous acidic brine within a desired range of brine level, pH and salinity.

In some embodiments, the process is conducted in a continuous manner.

In some embodiments, the aqueous acidic brine is circulated within the at least one container.

In some embodiments, the aqueous acidic brine is contacted with the olives at about 5° C. to about 40° C., such as about 15° C. to about 25° C., for a period of about 2 weeks to about 20 weeks. In some further embodiments, the aqueous acidic brine is contacted with the olives at about 40° C. for a period of about 2 weeks to about 4 weeks.

In some embodiments, the pH of the aqueous acidic brine is adjusted by addition of an acid. In some further embodiments, the acid is selected from the group consisting of lactic acid and acetic acid.

In some embodiments, the pH of the aqueous acidic brine is maintained at about 3.5.

In some embodiments, the salinity of the aqueous acidic brine is maintained at about 8% w/v of the aqueous acidic brine.

In some embodiments, the olives are selected from the group consisting of whole olives, crushed olives, cut olives, ultrasonic treated olives, pitted olives, olive slices, olive particles, olive halves, and olives treated by any other process that speeds up the transfer of the bitter compounds from the olives to the brine.

In some embodiments, the bitter compounds are selected from the group consisting of phenolic acids, phenolic alcohols, flavonoids and secoiridoids. In some further embodiments, the bitter compounds are selected from the group consisting of oleuropein, ligstroside, oleoside, oleuropein aglycone, ligstroside aglycone, oleacein, oleocanthal, tyrosol, hydroxytyrosol and mixtures thereof.

In some embodiments, the brine from which one or more bitter compounds or colouring compounds have been removed is packed out together with the olives.

In some embodiments, the adsorbent resin that has been used is regenerated by treatment with hot water. In some embodiments, the adsorbent resin that has been used is regenerated by treatment with a lower alcohol. In some further embodiments, the lower alcohol is selected from the group consisting of methanol, ethanol and isopropanol. In some embodiments, the bitter compounds are recovered from the lower alcohol. Advantageously, the bitter compounds recovered may be used as a value added by-product.

In a second aspect, the present disclosure provides a process for debittering olives without intentional fermentation or lye treatment, the process comprising:
providing at least one container loaded with olives;
contacting an aqueous acidic brine with the olives under conditions sufficient to release at least some of any bitter compounds therefrom;
circulating the aqueous acidic brine within the at least one container;
maintaining the circulating aqueous acidic brine within the at least one container at a desired value of pH that is no higher than about 4.3 and at a desired value of salinity that is at least about 5% w/v of the aqueous acidic brine; and
contacting the aqueous acidic brine with an adsorbent resin so as to remove one or more of any bitter compounds or colouring compounds from the aqueous acidic brine that has been in contact with the olives.

In a third aspect, the present disclosure provides a process for producing table olives having a desired level of saltiness and/or bitterness, the process comprising:
providing at least one container loaded with olives;
contacting an aqueous acidic brine with the olives under conditions sufficient to release at least some of any bitter compounds therefrom;
circulating the aqueous acidic brine within the at least one container;
maintaining the circulating aqueous acidic brine within the at least one container at a desired value of pH that is no higher than about 4.3 and at a desired value of salinity that is at least about 5% w/v of the aqueous acidic brine; and
contacting the circulating aqueous acidic brine with the olives in the container until a desired level of saltiness and/or bitterness is reached in a majority of the olives.

The process of the second or third aspect may be carried out with reference to the process of the first aspect.

In a fourth aspect, the present disclosure provides edible olives obtained by the process of any of the first to third aspects.

In a fifth aspect, the present disclosure provides an apparatus for use in debittering olives, which comprises:
at least one container configured to hold olives;
a pump configured to circulate an aqueous acidic brine within the at least one container, which is in fluid communication with the at least one container;
one or more dosing apparatus in fluid connection with the at least one container and configured to maintain the circulating aqueous acidic brine within the at least one container at a desired volume or level within the container and at a desired value of pH that is no higher than about 4.3 and at a desired value of salinity that is at least about 5% w/v of the aqueous acidic brine; and
an adsorbent resin configured to contact the aqueous acidic brine so as to remove one or more of any bitter compounds or colouring compounds from the aqueous acidic brine that has been in contact with the olives.

In some embodiments of the fifth aspect, the one or more dosing apparatus comprises a dosing means adapted to introduce water or brine, an acid and/or salt into the at least one container in order to maintain a desired volume or level of brine in the container and/or a desired value of pH and/or salinity in the aqueous acidic brine in the container.

In some embodiments, the apparatus further comprises a pH measuring means configured to measure the pH of the brine.

In some embodiments, the apparatus further comprises a salinity measuring means configured to measure the salinity of the brine.

In some embodiments, the apparatus further comprises a brine level measuring means configured to measure the reduction in the brine level in the container.

In some embodiments, the at least one container is composed of a plurality of containers that are connected in fluid communication with one another. In some further embodiments, the containers are arranged in series. In some further embodiments, the containers are arranged in parallel. In some further embodiments, the containers are arranged in series and parallel.

In some embodiments, the apparatus further comprises a filter in fluid communication with the pump.

In some embodiments, the adsorbent resin is an ion exchange resin. In some other embodiments, the adsorbent resin is a non-ionic adsorbent resin. In some other embodiments, the adsorbent resin is a chelating adsorbent resin. In some embodiments, the adsorbent resin is disposed within the at least one container. In certain of these embodiments, the adsorbent resin is contained within one or more permeable sachets or housings within the at least one container. In some further embodiments, the adsorbent resin is disposed external to the at least one container. In certain of these embodiments, the adsorbent resin is disposed within the filter. In some further embodiments, the chemicals to be adsorbed by the resin are selected from bitter compounds, colouring substances and salts.

In some embodiments, the apparatus further comprises an acid supplier connected to the dosing means.

In some embodiments, the apparatus further comprises a salt supplier connected to the dosing means.

In some embodiments, the apparatus further comprises a brine supplier connected to the dosing means.

In some embodiments, the apparatus further comprises a water supplier connected to the dosing means.

### DESCRIPTION OF FIGURES

Embodiments of the present disclosure will be discussed with reference to the accompanying figures wherein:

FIG. 1 shows an illustrative arrangement of the at least one container using an internal pump and adsorbent resin, wherein each reference number represents: (1) a floating lid or a means that minimises air on the brine, (2) a grate to hold olives below the brine surface, (3) an optional basket to separate olives from the pump (salt and acid can be added to the basket), (4) a mixture of olives and brine, (5) adsorbent resin in a sachet, (6) a pump inlet, (7) a submersible pump, (8) a pump outlet, and (9) a pipe to recirculate and mix the brine which may have holes along its length.

FIG. 2 shows an illustrative arrangement of the at least one container using an external pump, wherein each reference number represents: (1) a floating lid or a means that minimises air on the brine, (2) represents a grate to hold olives below the brine surface, (3) a basket to hold adsorbent resin (optional), (4) a mixture of olives in brine, (5) an adsorbent resin canister (optional), (6) a pump inlet, (7) an external pump, (8) a pump outlet, (9) mixing before entering the pump, (10) an external entry to add brine, salt and acid (optional), and (11) the brine returning to the container. The resin can be held in the container for example in basket (3) and/or in the external circulating brine for example in an adsorbent resin canister (5).

FIG. 3 shows an illustrative arrangement of multiple containers in parallel using an external pump, wherein each reference number represents: (1) a floating lid or a means that minimises air on the brine, (2) a grate to hold olives below the brine surface, (3) a basket to hold adsorbent resin (optional), (4) a mixture of olives in brine, (5) a canister that holds adsorbent resin (optional), (6) a pump inlet, (7) an external pump, (8) a pump outlet, (9) mixing before entering the pump, (10) an entry to add brine, salt and acid (optional), and (11) the brine returning to the container. The resin can be held in the container for example in basket (3) and/or in the external circulating brine for example in an adsorbent resin canister (5).

FIG. 4 shows an illustrative arrangement of multiple containers in series using an external pump and adsorbent resin, wherein each reference number represents: (1) a floating lid or a means that minimises air on the brine, (2) a grate to hold olives below the brine surface, (3) a basket to hold adsorbent resin (optional), (4) a mixture of olives in brine, (5) a canister that holds adsorbent resin (optional), (6) a pump inlet, (7) an external pump, (8) a pump outlet, (9) mixing before entering the pump, (10) an entry to add brine, salt and acid (optional), and (11) the brine returning to the container. The resin can be held in the container for example in basket (3) and/or in the external circulating brine for example in an adsorbent resin canister (5).

FIG. 5 shows an illustrative arrangement of multiple containers that are connected one at a time to an external pump and adsorbent resin, wherein each reference number represents: (1) a floating lid or a means that minimises air on the brine, (2) a grate to hold olives below the brine surface, (3) a basket to hold adsorbent resin (optional), (4) a mixture of olives in brine, (5) a canister that holds adsorbent resin (optional), (6) a pump inlet, (7) an external pump, (8) a pump outlet, (12) a valve/s which directs flow from the pump to a particular container, (13) and overflow pipe from a container to a brine holding tank and (14) a brine holding tank from which the pump draws brine for recirculation and into which extra brine, salt and acid can be added. The resin can be held in the container for example in basket (3) and/or in the external circulating brine for example in a canister (5).

### DESCRIPTION OF EMBODIMENTS

The term “olive” or “olives” used herein refers to the fruit of the species Olea europaea, its subspecies and its cultivars. Olives may be whole olives, crushed olives, cut olives, ultrasonic treated olives, pitted olives, olive slices, olive particles, olive halves, and olives treated by any other process that speeds up transfer of the bitter compounds from the olives to the brine.

The term “debitter(ing)” used herein means removing at least some of any bitter compounds present in the flesh of olives. The extent of debittering can depend on the desired taste of the olive product, or the desired quantity of bitter compound to be isolated from the olive flesh. It will be appreciated that debittering may not require removal of all bitter compounds or all of any specific bitter compound. Rather, a sufficient amount of a specific bitter compound or a range of bitter compounds is removed to make the olive palatable or edible but it still has a desired level of remaining bitterness.

The term “bitter compounds” used herein refers to compounds contributing to olive bitterness and normally includes phenolic compounds present in harvested olives, which may be grouped into four broad categories: phenolic acids, phenolic alcohols, flavonoids, and secoiridoids. Specific examples of compounds that can be removed from olives in the processes described herein include oleuropein (i.e., (4S,5E,6S)-4-[2-[2-(3,4-dihydroxyphenyl)ethoxy]-2-oxoethyl]-5-ethylidene-6-[[(2S,3R,4S,5S,6R)-3,4,5-trihydroxy-6-(hydroxymethyl)-2-tetrahydropyranyl]oxy]-4H-pyran-3-carboxylic acid, methyl ester), oleuropein aglycone, monoaldehyde form, oleuropein aglycone, dialdhyde form, tyrosol, hydroxytyrosol, ferulic acid, oleacein, oleocanthal, vanillic acid, caffeic acid, p-coumaric acid, ligstroside, ligstroside aglycone monoaldehyde form, ligstroside aglycone dialdehyde form, oleoside vanillin, cinnamic acid, pinoresinol, 1-acetoxy pinoresinol, and luteolin. The quantity of a given compound will depend, in part, on the subspecies or cultivar of the olives used in the process, growing conditions and the level of ripeness of the olives.

As used herein, the term “secoiridoid” refers to a monoterpene-type natural product found in olive flesh. In general, a secoiridoid contains a 3,4-dihydro-2H-pyran-2-ol moiety. The 2-hydroxy group in the pyran-2-ol moiety can be glycosylated with a sugar molecule. Examples of secoiridoids contained in olives include, but are not limited to, oleuropein, oleuropein aglycone, oleuropein-3″-methyl ether, (7″S)-hydroxyoleuropein, jaspolyanoside, ligustroside 3′-glucoside, jaspolyoside, isojaspolyoside A and oleuropein 3′-O-β-D-glucoside.

The term “colouring compound(s)” used herein refers to substances originated from olives that can be removed therefrom and enter into the brine to make the latter cloudy and coloured.

The term “fermentation” used herein refers to a fermentation process carried out on olives by use of field borne and/or added microorganisms (such as yeast that create lactic acid bacteria; Enterobacteriaceae, Clostridium, Pseudomonas, and Staphylococcus and occasionally moulds). This results in degradation of sugars, oils and phenolic compounds present in olives and contributes to the development of structural and sensory characteristics.

The term “lye treatment” used herein refers to treating olives with an alkaline lye. For instance, this may involve putting and keeping olives in a NaOH solution (e.g. 2%) for a certain period and then washing olives with water several times to remove the excess of alkali solution remaining on the olives. This process also needs to be done soon after harvest.

The term “brine” used herein refers to a solution comprising salt and water.

The term “salinity” used herein refers to the amount of salt dissolved in the brine. It can be measured using a specific gravity or salinity sensor. The term “salt” used herein refers to edible salt, such as rock salt and sea salt which primarily comprises sodium chloride. Unless otherwise specifically stated, reference herein to a salinity of X % w/v is based on the volume of the aqueous acidic brine.

Table olives are defined by the International Olive Oil Council (IOOC) (1990) as “the sound fruit of specific varieties of the cultivated olive tree harvested at the proper stage of ripeness and whose quality is such that, when they are suitably processed as specified in the standard, they produce an edible product and ensure its good preservation as marketable goods.”

The processes disclosed herein have the advantage of enabling the production of table olives to be carried out in a controlled manner in both a small and large scale, in an automated or semi-automated process, with a high level of process control and in a more cost-effective manner than the state of the art, which leads it to be readily adaptable to running automatically on an industrial scale. Furthermore, the processes disclosed herein are advantageous in eliminating the need for disposal of large amounts of waste brine solutions. The proper use of the brine circulating through the appropriate type and quantity of resin keeps the brine clear and fresh throughout the debittering process. In addition, the processes disclosed herein enable the production of table olives having control over the final salt and/or bitterness levels to match product to specific consumer tastes. For example, the processes disclosed herein produce table olives with an anecdotally firmer texture and a sweeter olive fruit taste. Without intending to be bound by a specific theory, table olives produced by the processes disclosed herein may have a different taste and or texture to table olives produced by fermentation and this may be due, at least in part, to the fact that natural sugars and oils present in the olive fresh are not broken down to anywhere near the same extent in the processes disclosed herein when compared to traditional fermentation or lye processes.

Disclosed herein is a process for debittering olives without intentional fermentation or lye treatment. The process comprises providing at least one container loaded with olives and contacting an aqueous acidic brine with the olives under conditions sufficient to release at least some of any bitter compounds or colouring compounds therefrom. The aqueous acidic brine is circulated within the at least one container and maintaining the circulating aqueous acidic brine within the at least one container at a desired value of pH that is no higher than about 4.3 and at a desired level of salinity that is at least about 5% w/v of the aqueous acidic brine. The aqueous acidic brine is contacted with an adsorbent resin so as to remove one or more of any bitter compounds or colouring compounds from the aqueous acidic brine that has been in contact with the olives.

Also disclosed herein is a process for debittering olives without intentional fermentation or lye treatment. The process comprises providing at least one container loaded with olives and contacting an aqueous acidic brine with the olives under conditions sufficient to release at least some of any bitter compounds or colouring compounds therefrom.

The processes disclosed herein can be conducted in a continuous manner and can be either manually adjusted or can be made semi-automatic or fully automatic.

Generally, any type of olive can be debittered using the processes disclosed herein, including known varieties and varieties that may be developed in the future. Suitable olives include, but are not limited to, Frantoio olives, Kalamata olives, Arbequina olives, Barnea olives, Del Morocco olives, Koroneiki olives, Leccino olives, Oblitza olives, Manzanilla olives, Hojiblanca olives and Picual olives. In some embodiments, the olives are Frantoio ripened black olives.

Advantageously, it has been found that the ripeness and size of the olives does not noticeably affect the progress of the debittering processes disclosed herein. In some embodiments, green olives are used. In other embodiments, olives close to full ripeness are used. Olives that are overripe are not recommended, as they lose their firmness. In some embodiments, the olives to be debittered have been cut (for example, into slices or having a surface cut thereon) or pitted and this requires less time to debitter the olives.

As one of the advantages produced by the processes disclosed herein, the olives are debittered without being subjected to intentional fermentation or lye treatment. This means the olives to be contacted with the aqueous acidic brine have not undergone intentional fermentation or lye treatment.

In some embodiments, harvested olives are directly used in the debittering processes disclosed herein. In other embodiments, harvested olives are subjected to sorting with regard to their size and colour, and washed prior to the debittering processes disclosed herein. If needed, the olives are sorted before being used in the debittering processes disclosed herein for the purpose of removing damaged, blemished or shrivelled olives.

The container(s) used herein for the debittering of olives may be in any form as long as they are adaptable for use in the processes disclosed herein. For instance, the container(s) can be those that are capable of maintaining a constant temperature. It is desirable for the container(s) to assist in avoiding any photo sensitive reaction in the olives. For instance, the container(s) can be made from non-transparent material. It is also possible to keep the container(s) made from a transparent material in a dark place. The container(s) can be sealed or open to atmosphere. It may be desirable for containers to have a top exit or an air release pathway in order to avoid air leaving the olives from pressurising the container. In some embodiments, a sensor for measuring brine level of the aqueous acidic brine is used to automatically control the topping up level of brine in the container(s) or to monitor the reduction in the brine level, as the olives release some intercellular air and shrink in size. In certain of these embodiments, the brine level of the aqueous acidic brine is monitored on a regular basis. When contacting the aqueous acidic brine with the olives to remove bitter compounds, the container(s) are preferably sealed with minimal air ingress and may only be opened to take samples for checking. The processes can be run with small air/brine interfaces during the debittering stage. However, the use of sealed container(s) will minimise oxygen interaction with the aqueous acidic brine which can lead to a Kahm yeast being produced and this can cause unintentional fermentation and lead to unwanted off flavours in the olives and precipitates in the brine. The present inventor has advantageously found that unintentional fermentation tends to occur at low flow/mixing rates at the air/brine interface when the pH approaches 4. For example, at flow rates of greater than about 12 litres per minute though an open conventional 220 litre olive barrel the likelihood of unintentional fermentation may be reduced. In some embodiments, the flow rate of the circulating aqueous acidic brine in the container is from about 5 litres per minute to about 12 litres per minute.

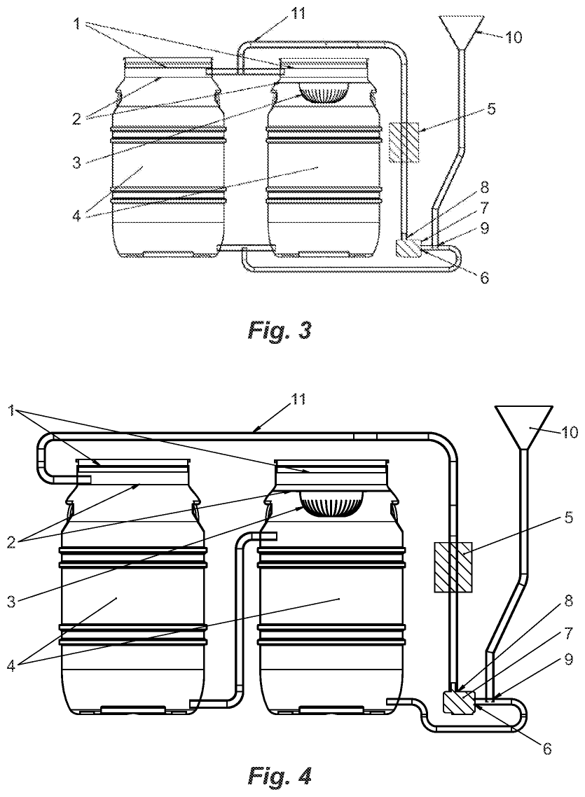

In some embodiments, the at least one container is composed of a plurality of containers. The containers may be connected in fluid communication with one another and can be arranged in parallel, in series or in a mixed series and parallel manner. FIG. 3 shows an embodiment wherein the containers are fluidly connected with one another in parallel through a pipeline. FIG. 4 shows an embodiment wherein the containers are arranged in series and are connected in fluid communication with one another. In these embodiments, each of the containers has a feed line and discharge line. Optionally, the feed line and discharge line can be connected to a valve selector that may select the containers to be running. The valve selector can be controlled manually or through a centralised monitoring and control system which will be detailed hereinafter. If needed, the process disclosed herein can be scaled from 1 to 100+ containers.

The aqueous acidic brine is contacted with the olives provided in the container(s) under conditions sufficient to release at least some of any bitter compounds therefrom. It is suggested that all of the olives should be fully submerged under the brine when contacting with the brine. To prevent bruising of olives, the container(s) may be filled with a small amount of brine before adding the olives. After loading the olives and the brine in the container(s), the container(s) can be sealed and, if needed, the temperature of the brine or container(s) may be adjusted.

The aqueous acidic brine is circulated within the at least one container. For example, at least one recirculation pump can be attached in fluid communication to the container(s) to circulate the aqueous acidic brine in each container in order to remove pH and salinity gradients within each container.

The aqueous acidic brine circulated within the at least one container is maintained at a desired value of pH that is no higher than about 4.3 and at a desired value of salinity that is at least about 5% w/v of the aqueous acidic brine.

A pH sensor and a salinity sensor can be used to monitor the aqueous acidic brine within the container(s) so as to ensure that each of the pH and salinity is kept at a desired value throughout the debittering process. The desired values may change from the start to end of debittering.

In some embodiments, the pH of the aqueous acidic brine is adjusted by addition of an acid. Any food grade acid can be used. Particularly suitable acids may be those selected from the group consisting of lactic acid and acetic acid. The pH of the aqueous acidic brine is maintained at less than about 4.3. In addition, natural fermentation process produces lactic acid which helps with the debittering. Acetic acid in the form of vinegar is often added to cured olives to achieve the required pH of less than 4.3 in packed olives.

In some embodiments, the salinity of the aqueous acidic brine is maintained at a value of from about 8% to about 10% w/v of the aqueous acidic brine. In the case of a plurality of containers, salt is suggested to be added as dry solids (for example, granules) to an offtake of the brine and be mixed together with the offtake (for example, in a mixing container) which is then dosed back into the flow of brine. This minimises the addition of liquid to the brine.

When the aqueous acidic brine is contacted with the olives, the salt and acid from the brine diffuse into the olives and the debittering process commences immediately. The bitter phenolic compounds progressively diffuse out of the olives into the brine and are thus removed from the olive flesh. This changes the chemical and sensory profile of the olives. If the cellular structure of the olive skin and flesh is compromised, for example by cracking, slitting or pitting, diffusion of salt and acid into the olive and bitter phenolic compounds out of the olive can occur more rapidly.

The resin adsorbing the bitter compounds keeps the brine low in concentration of bitter compounds and thus maximises the potential rate of diffusion from the olive to the brine. This achieves a result similar to full brine replacement without any additional action and the subsequent need to dispose of the waste brine.

Salt also helps to reduce the water activity and prevent the growth of spoilage microorganisms. The brine is required to be kept at a salinity of at least about 5% w/v and no more than 12% w/v of the aqueous acidic brine. If there is too little salt, the brine and olives are prone to spoilage by bacteria, yeasts and moulds. If they form they can devalue the olives. If there is too much salt (>12% w/v), the olives will shrivel and be unpleasant for consumption. In some embodiments, a high level of starting salinity (for example about 10% w/v) is used to account for the absorption of salt by the olives and depending on the brine to olive ratio there may still remain enough salt (for example about 5% w/v) in the brine at the end of the processes disclosed herein.

The brine used herein should be maintained at a pH no higher than about 4.3. A brine with a pH<4.3 and a salinity >6% w/v acts as a preservative that stops bacterial spoilage. Furthermore, if the pH is too high, the bitterness might not be lost after a certain period.

In some embodiments, the aqueous acidic brine is maintained in contact with the olives at a temperature of from about 5° C. to about 40° C. for a period of about 2 week to about 20 weeks. In some further embodiments, the aqueous acidic brine is maintained in contact with the olives at a temperature of from about 40° C. for a period of about 2 weeks to about 4 weeks. Generally, the debittering is quicker as temperature rises. It can be seen that the processes disclosed herein significantly reduce the time for contacting the brine with the olives when compared to current natural fermentation debittering processes. The temperature of the aqueous acidic brine can be maintained using a suitable heater or chiller. For example, the temperature of the aqueous acidic brine can be controlled external from the container(s) holding the olives using a heater or chiller.

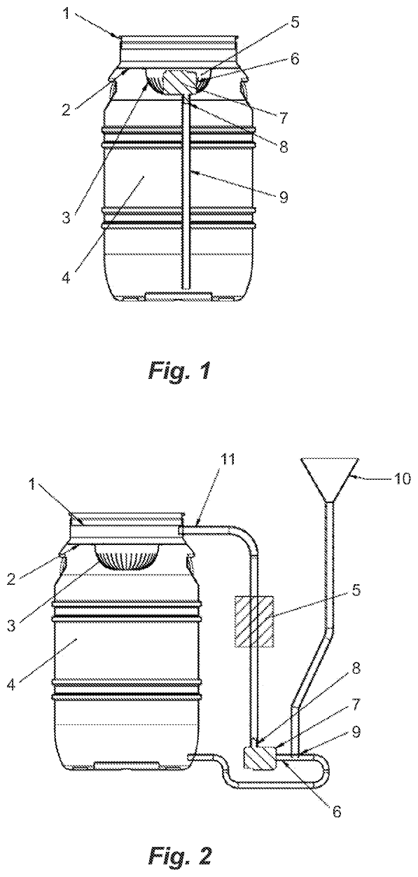

After debittering commences, the pH and salinity of the brine are monitored on a regular basis, for example, continuously or semi-continuously. The pH and salinity of the brine may be measured, and hence monitored, using a suitable pH sensor and a suitable salinity sensor, respectively. The measurements can be carried out at any suitable, such as daily, twice daily or hourly intervals. Based on the measured pH and salinity values, an aqueous solution containing salt which has a salinity of more than about 5% w/v of the aqueous acidic brine and/or an aqueous solution containing acid which has a pH of less than 3.5 can be introduced into the circulating aqueous acidic brine (e.g. by a dosing pump) for adjustment. In addition or as an alternative, an amount of salt is added as dry solids (for example, granules) directly into the container fitted with a basket (Item 3 in FIGS. 1 to 5) or into the recirculating pump (Item 10 in FIGS. 1 to 4) so as to pass through the pump entry to assist with dissolving. A recirculation pump may be running either continuously or intermittently to remove pH and salinity gradients within the containers. This further enables automatic checking of pH and salinity as well as automatic dosing of salt and acid to achieve required levels of these parameters.

A sensory test for the olives can be conducted on a weekly basis. Once olives have achieved the desired bitterness and flavour profile, the container(s) can be monitored and controlled for a pack-out pH and salinity in readiness for packing out. Prior to packing out the olives can be exposed to oxygen to darken the skin. Once packed, the olives are pasteurised to kill all microorganisms. Alternatively, the olives can be pasteurised prior to packing by for example, inline pasteurisation to stabilise the debittered olives whilst waiting for pack out.

The processes described herein provide a user with a unique ability to tailor table olives to multiple sets of consumer tastes. The preferred saltiness and bitterness of olives is very dependent on individual consumer tastes or preferences. Until the processes disclosed herein, there has been no method known to the applicant that allows one to consistently achieve a desired saltiness and/or bitterness in olives on a commercial scale. Thus, also disclosed herein a process for producing table olives having a desired level of saltiness and/or bitterness, the process comprising:
providing at least one container loaded with olives;
contacting an aqueous acidic brine with the olives under conditions sufficient to release at least some of any bitter compounds therefrom;
circulating the aqueous acidic brine within the at least one container;
maintaining the circulating aqueous acidic brine within the at least one container at a desired value of pH that is no higher than about 4.3 and at a desired value of salinity that is at least about 5% w/v of the aqueous acidic brine;
contacting the circulating aqueous acidic brine with the olives in the container until a desired level of saltiness and/or bitterness is reached in a majority of the olives; and
contacting the aqueous acidic brine with an adsorbent resin so as to remove one or more of any bitter compounds or colouring compounds from the aqueous acidic brine that has been in contact with the olives.

The brine may be regenerated or cleaned using filters and/or an adsorbent resin before transforming the olives and the brine into a packaged product. The adsorbent resin captures the bitter compounds and colouring substances so as to provide a replenished brine which can be packed out with the olives or used again in the next debittering process. Alternatively, an adsorbent resin and filters (such as reverse osmosis) may be used to reduce the salinity of the used brine to provide a clear brine which can be packed out with the olives.

In some embodiments, the adsorbent resin is an ion exchange resin. In some other embodiments, the adsorbent resin is a non-ionic adsorbent resin. In some other embodiments, the adsorbent resin is a chelating adsorbent resin. Examples of suitable adsorbent resins include, but are not limited to, AmberLite™ resins and Seplite™ resins. For this purpose, Amberlite™ resins XAD4, XAD16N, XAD7HP, and FPX66 or Seplite™ resin LXA6 may be used.

Testing by the inventors showed that resins could achieve cleaning of the brine and keeping it clear.

Cleaning of the brine using an adsorbent resin allows:
Lower concentrations of bitter compounds in the brine and hence, maximising the diffusion rate of these compounds from the olive to the brine.
Negates the need to change the brine with fresh brine.
The curing brine to be packaged with the olives and hence remove the need to dispose of the curing brine.
Recovery of the chemicals and colouring removed from the olives if the resin is regenerated using a solvent.

In some embodiments, the adsorbent resin may be disposed within the at least one container. For example, the adsorbent resin can be added directly into the one or more container(s). When the adsorbent resin is introduced into the container(s), most will settle to the bottom and some will float. The resin may change colour (e.g. turn to orange, pink or purple) over time. The resin can be washed from the olives and then separated from the brine by use of a filter. Alternatively, and preferably the resin can be contained within a porous mesh bag or container (for example, a sachet) which is permeable to the brine but does not allow the escape of the resin. To allow easy checking, removal and replacement of the resin during debittering the resin in bags can be held in a basket (Item 3 in FIGS. 1 to 5).

As an alternative, the adsorbent resin may be disposed external to the at least one container. In this alternative, the adsorbent resin may be placed within a resin bed that is external to the one or more container(s) and the circulating aqueous acidic brine passes through the resin bed during circulation. It is advantageous if the olives do not come into direct contact with the adsorbent resin to allow easy replacement of the resin and not mix the resin with olives. The resin bed may be in the form of the adsorbent resin contained within a suitable housing, such as a resin column, filter housing or a permeable resin holder or sachet, and in fluid connection with the one or more container(s) and the recirculation pump. Testing has shown that 15 litres of Kalamata olives in deeply coloured brine can be cleaned to create a clear brine using 2 litres of resin in a filter unit with 4 hours of recirculation.

Thus, also disclosed herein is a process for debittering olives without intentional fermentation or lye treatment, the process comprising:
providing at least one container loaded with olives;
contacting an aqueous acidic brine with the olives under conditions sufficient to release at least some of any bitter compounds therefrom;
circulating the aqueous acidic brine within the at least one container;
maintaining the circulating aqueous acidic brine within the at least one container at a desired value of pH that is no higher than about 4.3 and at a desired value of salinity that is at least about 5% w/v of the aqueous acidic brine; and
contacting the circulating aqueous acidic brine with an adsorbent resin so as to remove one or more of any bitter compounds or colouring compounds from the aqueous acidic brine that has been in contact with the olives.

If desired, the used adsorbent resin can be regenerated for example, by contacting it with an organic solvent or hot water. In some instances, the resin is washed in a solvent for a period sufficient to remove adsorbed compounds including the bitter compounds. The solvent for regeneration may be a lower alcohol (e.g. methanol, ethanol and isopropanol), acetone and mixtures thereof. In the case of methanol, testing showed it took two hours to wash the resin. Alternatively, the resin can be washed in a lye solution. Lye washing is much faster in regenerating the resin but the by-products removed may be of lesser value.

Advantageously, the bitter compounds and/or colouring compounds can be recovered from the resin as value-added by-products, such as nutraceuticals, food colorants and UV absorbing surface treatments.

Also disclosed herein are edible olives obtained by the processes disclosed herein. In some embodiments, the edible olives obtained have an anecdotally firmer texture and a sweeter olive fruit taste compared to the ones prepared by natural fermentation or lye methods. The natural fermentation process breaks down the sugars in the olives to produce lactic acid. However, the processes disclosed herein retain the sugars and oils in the olives and keeps them fruitier and sweeter in taste.

Also disclosed herein is an apparatus for use in debittering olives, which comprises:
at least one container configured to hold olives;
a pump configured to circulate an aqueous acidic brine within the at least one container, which is in fluid communication with the at least one container;
one or more dosing apparatus in fluid connection with the at least one container and configured to maintain the circulating aqueous acidic brine within the at least one container at a desired volume or level within the container and at a desired value of pH that is below about 4.3 and at a desired value of salinity that is at least about 5% w/v of the aqueous acidic brine; and
an adsorbent resin configured to contact the aqueous acidic brine so as to remove one or more of any bitter compounds or colouring compounds from the aqueous acidic brine that has been in contact with the olives.

The apparatus may further comprise a pH measuring means configured to measure the pH of the brine and/or a salinity measuring means configured to measure the salinity of the brine. The apparatus may further comprise a brine level measuring means configured to control the topping up level of brine or measure the reduction in the brine level so that the circulating aqueous acidic brine is maintained at a desired volume or level within the container.

The one or more dosing apparatus may comprise a dosing means adapted to introduce an acid, brine, water and/or a salt into the brine in order to maintain a desired pH and/or salinity in the aqueous acidic brine in the container.

The at least one container can be composed of a plurality of containers that are connected in fluid communication with one another, or be a single container. In the case of a plurality of containers, the containers may be arranged in series, in parallel, or in series and parallel. The containers may be connected continually or intermittently together.

If needed, an acid supplier and/or a salt supplier can be provided to supply acid and salt to the brine flow within the apparatus. The acid supplier and/or the salt supplier can be connected to the dosing means which responds to a sensory test to dispense a required amount of acid or salt. The sensory test may be designed to produce measurement results in relation to pH, salinity, bitterness, clarity, overall acceptance, etc. The bitterness referred herein may be quantitatively measured by near-infrared spectroscopy in terms of the contents of bitter compounds. The bitterness and overall acceptance can also be qualitatively assessed by a panel as detailed hereinafter.

For the purpose of illustration, an illustrative arrangement of the at least one container (for example, an olive barrel) using an internal pump and adsorbent resin is provided in FIG. 1. A submersible pump (7) is placed within the container at the upper part thereof and the pump outlet (8) is connected to a pipe (9) extending to the lower part of the container. The pipe that may have holes along its length. The submersible pump (7) used herein may push fluid from the lower part of the container up to the upper part of the container so as to help recirculate and mix the brine within the container. It is optional to dispose a basket (3) at the upper part of the container, for example near the lid or seal (1) for the container, in order to separate olives from the submersible pump (7). The basket (3) may also facilitate in holding salt and/or acid that is (are) added to modify the brine (4) to remain within a desirable range of salinity and pH. A sachet of the adsorbent resin (5) (for example, one or more sachets) may also be kept in the basket (3) so as to be in contact with the flowing brine as the brine enters the pump and thus remove unwanted chemicals therefrom. The container shown is also equipped with a lid or a means (1) (e.g. in the form of a floating lid), which serves to keep air out of the container and thus avoid intentional fermentation. A lid allows sampling of the brine or the olives to be conducted. In addition, a means such as a grate (2) may be utilised to keep olives under the brine surface and it may be disposed below the lid or seal and above the pump as shown in FIG. 1. A top exit or an air release pathway (not shown) may be generated on the lid or seal (1) to avoid trapped air remaining with olives. It will be appreciated that devices such as a means for measuring pH, a means for measuring salinity, and a temperature regulator may be added to run the system. The olives can be monitored on a regular basis. When the properties of olives are considered as satisfactory, they may be transported together with at least some of the brine to a packaging station.

FIG. 2 shows an illustrative arrangement of the at least one container (for example, an olive barrel) using an external pump and adsorbent resin. Unlike the arrangement shown in FIG. 1, a pump (7) is disposed external to the at least one container. A pipeline connected to the pump is in fluid communication with the lower part of the container and may draw out a fluid from there and transfer it into the pump through a pump inlet (6). Before the fluid enters the pump via the inlet (6), it may be combined and mixed (9) with materials to be added into the container, such as brine/water, salt and acid. The fluid from the pump outlet (8) will then be directed via a pipeline into the upper part of the container. The brine returned at the upper part of the container (11) will mix with the brine within the container (4) and then pass through the olives with the aid of the pump (7). In this way, the brine will be circulated around through the container continuously or semi-continuously until the olives have a desirable taste. Optionally, a means such as a canister (5) may be disposed along the pipeline into the upper part of the container, which is configured to contain the adsorbent resins for removal of chemicals from the brine. Items added through the entry (10) shown in FIG. 2 may assist in regulating the salinity and pH of the brine within the container and/or topping up the brine within the container. If needed, an overflow line may be added to take excess brine out of the container, for example, transfer it to an overflow container. The container can be further designed in a similar way to that described for FIG. 1 and may have additional parts such as a lid or a means that minimises air on the brine (1), a grate to keep olives under brine surface (2), and an internal basket to hold the adsorbent resins (not shown). It would be appreciated that devices such as a means for measuring pH, a means for measuring salinity, a temperature regulator and a means for measuring brine level may be added for running the system.

FIG. 3 shows an illustrative arrangement of multiple containers connected in parallel using an external pump/s and adsorbent resin/s. Similar to the arrangement shown in FIG. 2, a pump (7) is disposed external to the containers. A pipeline connected to the inlet of the pump (6) is in fluid communication with the lower part of each of the containers, where the brine is drawn out from each of the containers. Then the brine is directed via the pump into a pipeline connected to the outlet of the pump (8) and in fluid communication with the upper part of each of the containers so that the brine returns to each of the containers (11). This process permits the brine to be circulated around through each of the containers. The containers and other devices can be designed as discussed with respect to FIG. 1 and FIG. 2.

FIG. 4 shows an illustrative arrangement of multiple containers connected in series using an external pump/s and adsorbent resin/s. Similar to the arrangement shown in FIG. 2, a pump (7) is disposed external to the containers. A pipeline connected to the inlet of the pump (6) is in fluid communication with the lower part of each of the containers, where the brine is drawn out from each of the containers. Then the brine is directed via the pump into a pipeline connected to the outlet of the pump (8) and in fluid communication with the upper part of each of the containers so that the brine returns to one the containers (11). Connecting pipelines are used to have the brine circulate progressively through each of the containers. The containers and other devices can be designed as discussed with respect to FIG. 1 and FIG. 2.

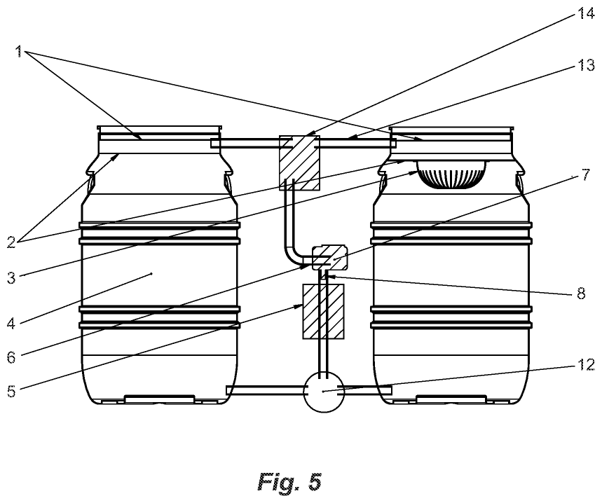

FIG. 5 shows an illustrative arrangement of multiple containers that are connected one at a time to an external pump and adsorbent resin. A pump (7) is disposed external to the containers. A pipeline connected to the inlet of the pump (6) is in fluid communication with the upper part of each of the containers via a brine holding tank (14), from which the pump draws brine for recirculation and into which extra brine, salt and acid can be added. Items added such as extra brine, salt and acid may assist in regulating the salinity and pH of the brine within the container(s) and/or topping up the brine within the container(s). Then the brine is directed via the pump into a pipeline connected to the outlet (8) of the pump and in fluid communication with the lower part of each of the containers via at least one valve (12), which directs the fluid from the pump to a particular container. Connecting pipelines are used to have the brine circulate through one or more container as desired. Along the external circulating brine is disposed an adsorbent resin canister (5) (optional), which is configured to contain the adsorbent resins for removal of chemicals from the brine. In addition or alternatively, the resin can be held in one or more containers, for example in basket (3). The containers and other devices can be designed as discussed with respect to FIG. 1 and FIG. 2.

When multiple containers are interconnected, only one pH sensor and one salinity sensor are disposed in the feed line or a container. The brine will pass through the containers in turn with the aid of the pump. The brine level in each container should be maintained to submerge the olives in the brine. The brine discharged from the last container is directed to the circulation pump and then returned to the feed line. In this way, the brine will be circulated around through the containers continuously or semi-continuously until the debittering process ends. Salinity and pH of the brine are monitored continuously or semi-continuously during the process by the pH sensor and the salinity sensor. When necessary, acid from an acid supplier and an aqueous solution of salt from a salt supplier are separately metered into the feed line or a container either manually or via a dosing pump to adjust any of pH and salinity to a desirable level. A heater or chiller could be added to modify the brine temperature.

Alternatively, a parallel layout of the containers can be used wherein each of the containers has a feed line connected to a valve selector. The valve selector is operated by means of a centralised monitoring and control module, which includes a pump, a manual or automatic dosing means for acid and salt, a sensing and logging means for pH, salinity, bitterness and clarity. After contacting with the olives therein, the brine flow will be discharged from that container as an overflow and returned to the pump and the centralised monitoring and control module. The brine level in each running container should be maintained to submerge the olives in the brine. In this way, the brine will be circulated around through the containers continuously or semi-continuously in a step wise manner until the debittering process ends. When the centralised monitoring and control module signals that pH and/or salinity of the brine need to be adjusted to a desirable level, acid and/or salt can be metered into the feed into the pump. It would be appreciated that each of the containers can be independently controlled through a valve arrangement and thus the debittering process can be easily scaled from 1 to 100+ containers.

### EXAMPLES

### Example 1—Debittering of Frantoio Olives

Olive debittering was conducted under varying temperature, physical modification, ripeness and quantity of adsorbent resins as detailed in Table 1. For all the trials the olives were placed in 1.5 litre glass jars containing an aqueous acidic brine solution. The salinity of the brine was started at 10% w/v of the aqueous acidic brine and the pH of 3.5. A typical aqueous acidic brine solution comprised:
1 litre vinegar
9 litres of water
1 kg salt

In all the treatments involving resins, the olives were started in surface contact with adsorbent resins. However, over time the resins sunk to the bottom and some of the olives rose to the top.

### Treatments

Ultrasonication: Frequency of 35 kHz; Power of 150 W; Time of 3 h; Mode of degas;
Cut: four surface cuts on olives
Compressed: olives were kept in one layer inside a zip-lock pouch and compressed using a wooden roller

TABLE 1
Treatment combinations for debittering olives

| | | | | Temp | Temp | Temp |
|---|---|---|---|---|---|---|
| | | | | First | Next | Re- |
| | | | | 28 | 35 | main- |
| Sample | Treatment | Ripeness | Resin | days | days | der |
| 1 | Temperature | Unripe | — | 4° C. | 4° C. | 4° C. |
| 2 | treatment (1) | Unripe | — | 20° C. | 20° C. | amb |
| 3 | | Unripe | — | 40° C. | 40° 14 days | |
| 4 | Temperature | Ripe | — | 4° C. | 4° C. | 4° C. |
| 5 | treatment (2) | Ripe | — | 20° C. | 20° C. | amb |
| 6 | | Ripe | — | 40° C. | 40° C. | amb |
| 7 | Resin treatment | Ripe | 0.5 | 20° C. | 40° C. | amb |
| 8 | (No surface | Ripe | 1 | 20° C. | 40° C. | amb |
| 9 | modification) | Ripe | 1.5 | 20° C. | 40° C. | amb |
| 10 | Resin treatment | Ripe | 0.5 | 20° C. | 40° C. | amb |
| 11 | (Ultra | Ripe | 0.75 | 20° C. | 40° C. | amb |
| 12 | sonication) | Ripe | 1 | 20° C. | 40° C. | amb |
| 13 | Resin treatment | Ripe | 0.5 | 20° C. | 40° C. | amb |
| 14 | (Surface cut) | Ripe | 0.75 | 20° C. | 40° C. | amb |
| 15 | | Ripe | 1 | 20° C. | 40° C. | amb |
| 16 | Resin treatment | Unripe | 0.5 | 20° C. | 40° C. | amb |
| 17 | (Compressed) | Unripe | 0.75 | 20° C. | 40° C. | amb |
| 18 | | Unripe | 1 | 20° C. | 40° C. | amb |

Seplite LXA6 resin was purchased from Sunresin New Materials Co. Ltd., Xi'an. The properties of the resin are tabulated in Table 2.

TABLE 2
Specification of Seplite resin LXA6

| Products | Seplite LXA6 |
|---|---|
| Matrix | Crosslinked polymer |
| Physical appearance | Ivory spheres |
| Particle size (mm) | 0.315-1.25 (95%) |
| Moisture (%) | 60-70 |
| Bulk density (kg/m³) | 650-750 |
| True density (kg/m³) | 1000-1100 |
| Surface area (m²/g) | ≥600 |
| Temperature limitation (° C.) | 0-110 |
| PH range | 0-14 |

Several quality parameters of the olive (var. Frantoio) were measured before conducting the debittering experiments with the values shown in Table 3.

TABLE 3
Quality parameters of olives taken for debittering

| Olive variety | Frantoio |
|---|---|
| True density (kg/m³) | 935 |
| Average single olive weight (g) | 3.36 |
| Size scale (fruit in 1 kg) | 291/320 |
| Flesh fraction (%) | 82.68 |
| Stone to flesh ratio | 1:4.77 |

Glass jars used for conducting the debittering treatments were sterilized. The jars were thoroughly washed with hot soapy water and then kept inside a hot air oven at 120° C. for 2 h.

The different debittering treatment conditions were:
(1) Whole ripe olives treated with resins,
(2) Compressed unripe olives treated with resins,
(3) Ultrasonicated ripe olives treated with resins,
(4) Surface cut ripe olives treated with resins,
(5) Ripe Olives kept at 20° C., and
(6) Ripe olives kept at 40° C.

The treated olives were kept in a dark box to avoid any photo sensitive reaction in the olives. The untreated samples were preserved in a refrigerated condition (<5° C.).

A panel conducted sensory analysis at weekly intervals for 8 weeks on the olives being debittered according to Table 1. It examined bitterness and overall acceptance of the olives according to the following scales. An acceptable table olive was judged as one that was in the like category of overall acceptance (i.e. a score of 6 to 9).

### Bitterness

| 1 | 2 | 3 | 4 | 5 |
|---|---|---|---|---|
| Very Low | Moderately | Optimal | Moderately | Very High |
| | Low | | High | |

### Overall Acceptance

| 1 | 2 | 3 | 4 | 5 | 6 | 7 | 8 | 9 |
|---|---|---|---|---|---|---|---|---|
| Dislike | Dislike | Dislike | Dislike | Neither | Like | Like | Like very | Like |
| extremely | very much | moderately | slightly | like nor | slightly | moderately | much | extremely |
| | | | | dislike | | | | |

Results showed that as the temperature increased so did the speed of debittering to achieve an acceptable table olive. Samples treated at 40° C. without use of resins achieved an acceptable product in about 3 weeks. It took an additional week for olives treated at 20° C. with resins to achieve an acceptable table olive.

No difference in the rate of debittering was found for ripe and unripe olives to become an acceptable table olive.

The cut treatment with the use of resins gave a much quicker curing of olives (1 week) than for compression, ultra-sonication or whole olives which took 5 weeks to achieve an acceptable table olive when held at 20° C.

### Example 2—Debittering of Kalamata Olives

A second experiment was conducted using a 15 litre beer fermenter tank that was placed in an oven set at 40° C. and fitted with an external pump and filter. The filter held 1 litre of resin. As the pump and filter unit was out of the oven, its cooling kept the brine temperature at around 32° C.

The fermenter was filled with brine which filled into the outer surface of the lid and kept air out of the fermenter. The pump and filter was run continuously for 4 weeks.

After 2 weeks the olives were deemed to be an acceptable table olive ready for consumption.

The size of the olive was not observed to have any significant effect on time to cure. Again there was no noticeable effect for curing time of ripe or unripe olives.

### Example 3—Regenerating the Resin

It was observed that the resins changed colour to be orange/pink/purple in colour during the above processes.

The MSDS for the Sunresin Seplite LXA6 states that for regeneration to use:
2-4% NaOH Caustic Soda solution at 85° C.
Minimum 45 minute contact
1-3×volume as flow per hour
Regenerate consumption 2-3 (number of washes to regenerate)
or
Organic solvents (methanol ethanol, acetone, isopropanol)
Hot water or steam for volatile materials

A test was made using a 3% NaOH solution added to the resin at around 70° C. The solution quickly turned black and the resin from pink to brown. The use of the NaOH solution would require disposal of the liquid and the material removed from the resin. With the NaOH wash, the resin remained a brown colour.

A second regeneration test was conducted by washing resins with methanol for the first time and the second time. The feature of using the methanol wash is that the methanol was able to be recovered using distillation. That means that methanol and the extracted components from the olives can then be separated by distillation and the extracted components can be recovered as value-added by-products.

A third regeneration test was conducted by washing resins with ethanol. The ethanol was recovered by distillation and the remaining extract was analysed for phenolic compounds by HPLC. The results are shown in Table 4.

TABLE 4
Compounds identified in an extract from
resin washed with ethanol and distilled

| | mg/kg extract | g/tonne olives |
|---|---|---|
| Hydroxytyrosol | 5,287.40 | 211.50 |
| Ferulic acid | 2,255.90 | 90.24 |
| Oleuropein | 1,441.70 | 57.67 |
| Tyrosol | 716.7 | 28.67 |
| Oleacein | 581.0 | 23.24 |
| Vanillic acid + caffeic acid | 201.2 | 8.05 |
| p-Coumaric acid | 183.6 | 7.34 |
| Oleuro aglycone, Al Hy | 110.7 | 4.43 |
| Decarb. Ligstr aglycone, Ox Al | 101.5 | 4.06 |
| Decarb. Oleuro aglycone, Ox Al | 60.3 | 2.41 |
| Ligstroside aglycone, Al | 44.0 | 1.76 |
| Oleuro aglycone, Ox Al Hy | 43.8 | 1.75 |
| Vanillin | 30.3 | 1.21 |
| Oleuro aglycone, Al | 27.7 | 1.11 |
| Cinnamic Acid | 18.1 | 0.72 |
| Pinoresinol + 1 Acetoxy pinore | 17.1 | 0.68 |
| Ligstroside aglycone, Al Hy | 14.9 | 0.60 |
| Ligstro aglycone, Ox Al Hy | 8.9 | 0.36 |
| Luteolin | 4.3 | 0.17 |
| Total Biophenols HPLC | 11,149.00 | 445.96 |

It will be appreciated by those skilled in the art that the disclosure is not restricted in its use to the particular application described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope of the disclosure as set forth and defined by the following claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

1. A process for debittering olives without intentional fermentation or lye treatment, the process comprising:
providing at least one container loaded with olives;
contacting an aqueous acidic brine with the olives under conditions sufficient to release at least some of any bitter compounds therefrom; and
contacting the aqueous acidic brine with an adsorbent resin so as to remove one or more of any bitter compounds or colouring compounds from the aqueous acidic brine that has been in contact with the olives.

2. The process according to claim 1, wherein the aqueous acidic brine within the at least one container is maintained at a desired value of pH that is no higher than about 4.3 and at a desired value of salinity that is at least about 5% w/v of the aqueous acidic brine.

3. The process according to claim 1, wherein the adsorbent resin is an ion exchange resin.

4. The process according to claim 1, wherein the adsorbent resin is disposed within the at least one container.

5. The process according to claim 1, wherein the adsorbent resin is disposed external to the at least one container.

6. The process according to claim 1, wherein the process is conducted in a continuous manner.

7. The process according to claim 1, wherein the aqueous acidic brine is contacted with the olives at a temperature of from about 5° C. to about 40° C. for a period of about 2 weeks to about 20 weeks.

8. The process according to claim 1, further comprising:
providing at least one container loaded with olives;
contacting an aqueous acidic brine with the olives under conditions sufficient to release at least some of any bitter compounds therefrom;
circulating the aqueous acidic brine within the at least one container;
maintaining the circulating aqueous acidic brine within the at least one container at a desired value of pH that is no higher than about 4.3 and at a desired value of salinity that is at least about 5% w/v of the aqueous acidic brine; and
contacting the aqueous acidic brine with an adsorbent resin so as to remove one or more of any bitter compounds or colouring compounds from the aqueous acidic brine that has been in contact with the olives.

9. A process for producing table olives having a desired level of saltiness and/or bitterness, the process comprising:
providing at least one container loaded with olives;
contacting an aqueous acidic brine with the olives under conditions sufficient to release at least some of any bitter compounds therefrom;
circulating the aqueous acidic brine within the at least one container;
maintaining the circulating aqueous acidic brine within the at least one container at a desired value of pH that is no higher than about 4.3 and at a desired value of salinity that is at least about 5% w/v of the aqueous acidic brine;
contacting the circulating aqueous acidic brine with the olives in the container until a desired level of saltiness and/or bitterness is reached in a majority of the olives;
contacting the aqueous acidic brine with an adsorbent resin so as to remove one or more of any bitter compounds or colouring compounds from the aqueous acidic brine that has been in contact with the olives.

10. (canceled)

11. An apparatus for use in debittering olives, which comprises:
at least one container configured to hold olives;
a pump configured to circulate an aqueous acidic brine within the at least one container, which is in fluid communication with the at least one container;
one or more dosing apparatus in fluid connection with the at least one container and configured to maintain the circulating aqueous acidic brine within the at least one container at a desired volume or level within the container and at a desired value of pH that is below about 4.3 and at a desired value of salinity that is at least about 5% w/v of the aqueous acidic brine; and
an adsorbent resin configured to contact the aqueous acidic brine so as to remove one or more of any bitter compounds or colouring compounds from the aqueous acidic brine that has been in contact with the olives.

12. The apparatus according to claim 11, wherein the adsorbent resin is disposed within the at least one container.

13. The apparatus according to claim 11, wherein the adsorbent resin is disposed external to the at least one container.

14. The apparatus according to claim 11, wherein the adsorbent resin is disposed within and external to the at least one container.
